(19) United States
(12) Patent Application Publication
(10) Pub. No.: US 2026/0323020 A1
(43) Pub. Date: Oct. 15, 2026

(54) METHOD AND APPARATUS FOR INTER-PREDICTION SIGNAL-BASED CROSS-COMPONENT PREDICTION

(71) Applicants: HYUNDAI MOTOR COMPANY, Seoul (KR); KIA CORPORATION, Seoul (KR); KWANGWOON UNIVERSITY INDUSTRY-ACADEMIC COLLABORATION FOUNDATION, Seoul (KR)

(72) Inventors: Joo Hyung Byeon, Seoul (KR); Min Hun Lee, Uijeongbu-si (KR); Dong Gyu Sim, Seoul (KR); Jung Ah Choi, Seoul (KR); Jin Heo, Yongin-si (KR); Seung Wook Park

(73) Assignees: HYUNDAI MOTOR COMPANY, Seoul (KR); KIA CORPORATION, Seoul (KR); KWANGWOON UNIVERSITY INDUSTRY-ACADEMIC COLLABORATION FOUNDATION, Seoul (KR)

(21) Appl. No.: 19/483,944

(22) PCT Filed: Mar. 27, 2024
(86) PCT No.: PCT/KR2024/003837

§ 371 Date: Nov. 12, 2025

(30) Foreign Application Priority Data
May 15, 2023 (KR) 10-2023-0062589
Mar. 26, 2024 (KR) 10-2024-0041180

(51) Int. Cl. H04N 19/117; H04N 19/139; H04N 19/176; H04N 19/186; H04N 19/52; H04N 19/80

(52) U.S. Cl. CPC H04N 19/117; H04N 19/139; H04N 19/176; H04N 19/186; H04N 19/52; H04N 19/80

(57) ABSTRACT

A method and an apparatus are disclosed for video coding using an inter-predicted signal-based cross-component prediction. The video decoding device generates first predicted signals of the current chroma block by using motion information. The video decoding device obtains luma predicted signals and luma reconstruction samples of luma blocks in a corresponding luma region. The video decoding device derives filter coefficients for cross-component prediction of the current chroma block by using the luma predicted signals and the first predicted signals. The video decoding device generates second predicted signals of the current chroma block by applying the filter coefficients to the luma reconstruction samples.

### TECHNICAL FIELD

The present disclosure relates to a video coding method and an apparatus using an inter-predicted signal-based cross-component prediction.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

In enhanced compression model (ECM), a next-generation technology, the cross-component residual model mode (CCRM mode) is applied to the prediction of chroma components when their corresponding luma block in a single tree is predicted according to inter prediction or intra block copy mode (IBC mode). The CCRM mode derives convolutional filter coefficients based on the relationship between the predicted signals of the corresponding luma components and the predicted signals of the chroma components. The CCRM mode predicts the chroma components by applying the derived filters to the reconstructed signals of the corresponding luma components.

In the open-source video codec AV1, the chroma from luma mode (CFL mode) predicts, during intra prediction, the alternating current (AC) components of the chroma components by using the AC components of the reconstructed luma components. The CFL mode subtracts from the reconstructed luma components, the average, i.e., direct current (DC) to generate the AC components of the luma components. The CFL mode predicts the AC components of the chroma components by multiplying the AC components of the luma components by a scaling parameter, and predicts DC components of the chroma components by using reference samples. The CFL mode sums the predicted DC components and AC components to generate the final predicted signals of the chroma components.

As described above, the CCRM mode is applied to cross-component prediction in a single tree structure, and the CFL mode is applied to cross-component prediction in intra prediction. Therefore, to improve video coding efficiency and video quality, when performing cross-component prediction on the chroma component, there is a need for a method of efficiently utilizing the corresponding luma components in various environments.

### DISCLOSURE

### Technical Problem

The present disclosure seeks to provide a video coding method and an apparatus that, when a corresponding luma block is encoded by inter prediction, intra-block copy mode (IBC mode), or intra template matching prediction mode (IntraTMP mode), perform cross-component prediction on chroma components based on signals predicted according to motion information.

### Technical Solution

At least one aspect of the present disclosure provides a method of reconstructing a current chroma block by a video decoding apparatus. The method includes generating first predicted signals of the current chroma block by using motion information that is a motion vector or a block vector. The method also includes obtaining luma predicted signals and luma reconstruction samples of luma blocks in a corresponding luma region. The method also includes deriving filter coefficients for cross-component prediction of the current chroma block by using the luma predicted signals and the first predicted signals. The method also includes generating second predicted signals of the current chroma block by applying the filter coefficients to the luma reconstruction samples.

Another aspect of the present disclosure provides a method of encoding a current chroma block by a video encoding apparatus. The method includes generating first predicted signals of the current chroma block by using motion information that is a motion vector or a block vector. The method also includes obtaining luma predicted signals and luma reconstruction samples of luma blocks in a corresponding luma region. The method also includes deriving filter coefficients for cross-component prediction of the current chroma block by using the luma predicted signals and the first predicted signals. The method also includes generating second predicted signals of the current chroma block by applying the filter coefficients to the luma reconstruction samples.

Yet another aspect of the present disclosure provides a computer-readable recording medium storing a bitstream generated by a video encoding method. The video encoding method includes generating first predicted signals of a current chroma block by using motion information that is a motion vector or a block vector. The video encoding method also includes obtaining luma predicted signals and luma reconstruction samples of luma blocks in a corresponding luma region. The video encoding method also includes deriving filter coefficients for cross-component prediction of the current chroma block by using the luma predicted signals and the first predicted signals. The video encoding method also includes generating second predicted signals of the current chroma block by applying the filter coefficients to the luma reconstruction samples.

### Advantageous Effects

As described above, the present disclosure provides a video coding method and an apparatus that perform cross-component prediction on chroma components based on signals predicted according to motion information when a corresponding luma block is encoded by inter prediction, IBC mode, or IntraTMP mode. Thus, the video coding method and the apparatus improve the coding performance of the chroma components, increase video coding efficiency, and enhance video quality.

### BRIEF DESCRIPTION OF THE DRAWINGS

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a diagram illustrating the prediction of chroma components according to the cross-component residual model mode (CCRM mode).

FIG. 7 is a diagram illustrating reconstructed signals of luma components subjected to a convolution filter.

FIG. 8 is a diagram illustrating the prediction of the chroma component according to the chroma from luma mode (CFL mode).

FIG. 9 is a block diagram showing in detail a part of a video decoding apparatus according to at least one embodiment of the present disclosure.

FIG. 10 is a block diagram showing in detail a prediction performer according to at least one embodiment of the present disclosure.

FIG. 11 is a diagram illustrating a reconstructed sample region used for deriving a scaling parameter, according to at least one embodiment of the present disclosure.

FIGS. 12A to 12C are diagrams illustrating reconstructed sample regions used for deriving the scaling parameter according to other embodiments of the present disclosure.

FIG. 13 is a diagram illustrating the derivation of scaling parameters according to at least one embodiment of the present disclosure.

FIG. 14 is a diagram illustrating reconstructed signals of luma components subjected to a convolution filter, according to at least one embodiment of the present disclosure.

FIG. 15 is a diagram illustrating the cross-component prediction of chroma components, according to at least one embodiment of the present disclosure.

FIG. 16 is a diagram illustrating predefined positions within a corresponding luma region according to at least one embodiment of the present disclosure.

FIG. 17 is a diagram illustrating locations for checking the prediction mode of neighboring blocks, according to at least one embodiment of the present disclosure.

FIG. 18 is a flowchart of a method of encoding a current chroma block by a video encoding apparatus, according to at least one embodiment of the present disclosure.

FIG. 19 is a flowchart of a method of reconstructing a current chroma block by a video decoding apparatus, according to at least one embodiment of the present disclosure.

FIG. 20 is a flowchart of a method of encoding a current chroma block by a video encoding apparatus, according to another embodiment of the present disclosure.

FIG. 21 is a flowchart of a method of encoding a current chroma block by a video encoding apparatus, according to another embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

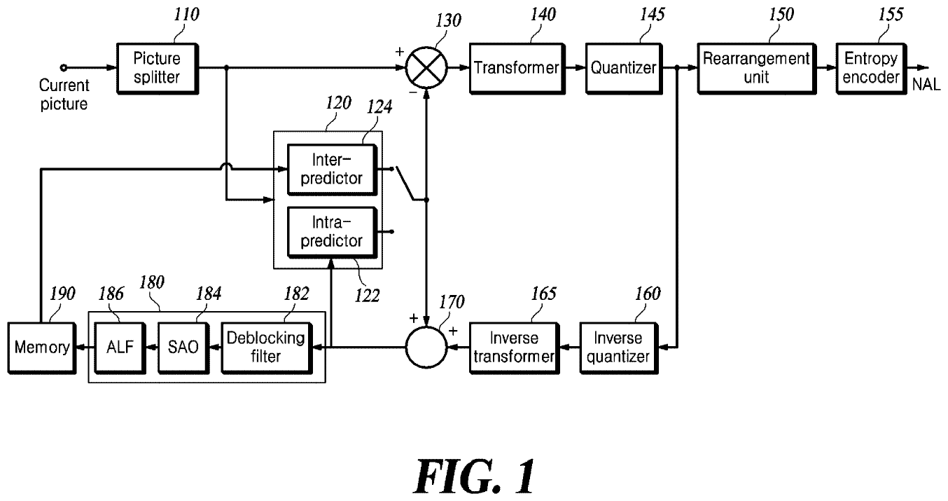

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

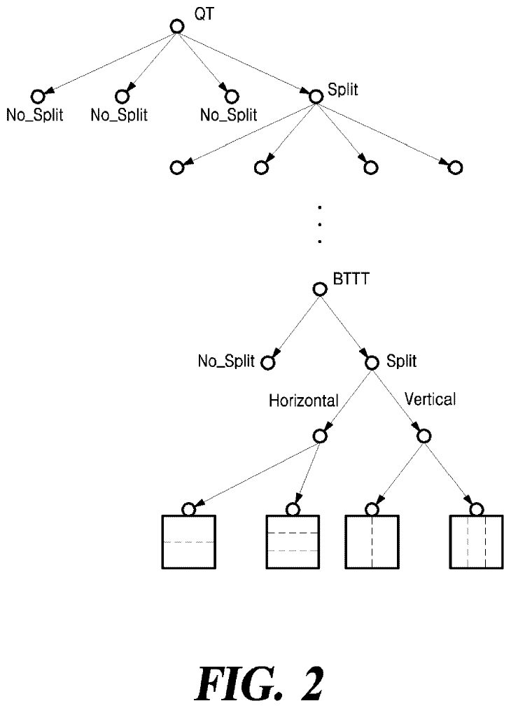

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

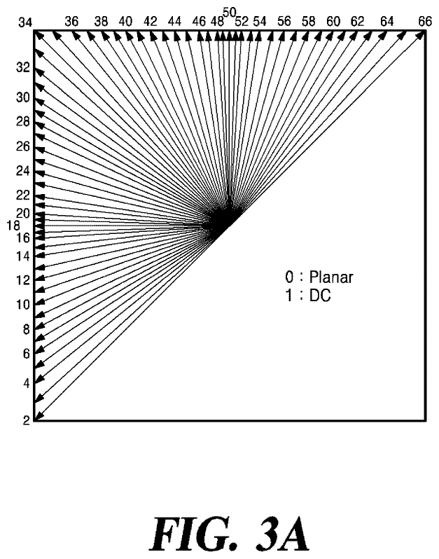

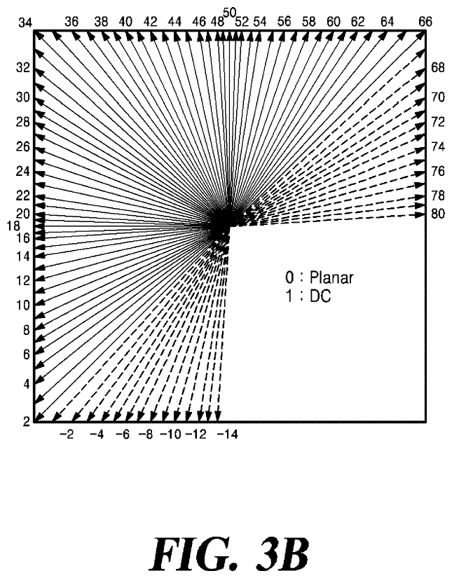

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (intra prediction modes #67 to #80, #−1 to #−14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than −135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

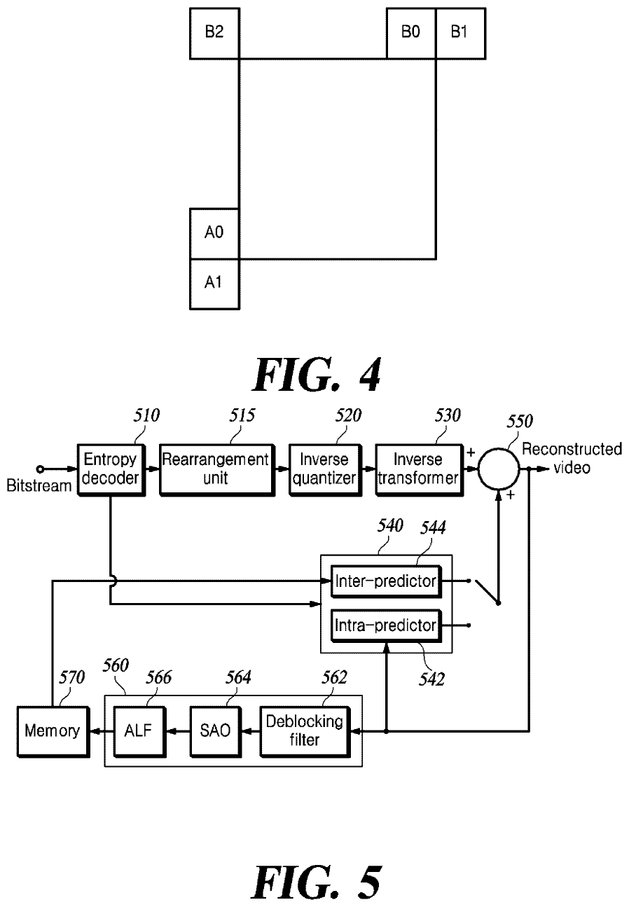

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

The video encoding device may store a bitstream of encoded video data in a non-transitory storage medium or transmit the bitstream to the video decoding device through a communication network.

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform function or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510, and predicts the current block by using the motion vector and the reference picture.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, the present disclosure provides a video coding method and an apparatus apparatuses that perform a cross-component prediction on the chroma component based on signals predicted by motion information, when the corresponding luma block is encoded in inter prediction, intra block copy mode (IBC mode), or intra template matching prediction mode (IntraTMP mode).

The following embodiments may be performed by the predictor 120 in the video encoding device. The following embodiments may also be performed by the predictor 540 in the video decoding device.

The video encoding device in encoding the current block may generate signaling information associated with the present embodiments in terms of optimizing rate distortion. The video encoding device may use the entropy encoder 155 to encode the signaling information and transmit the encoded signaling information to the video decoding device. The video decoding device may use the entropy decoder 510 to decode, from the bitstream, the signaling information associated with the decoding of the current block.

In the following description, the term “target block” may be used interchangeably with the current block or coding unit (CU), or may refer to some area of a coding unit.

Further, the value of one flag being true indicates when the flag is set to 1. Additionally, the value of one flag being false indicates when the flag is set to 0.

### I. INTRA BLOCK COPY (IBC) AND INTRATMP

IBC uses a block vector for copying the reference block within the common frame to generate the prediction block of the current block, thereby performing intra prediction of the current block.

The video encoding apparatus performs block matching to derive the optimal block vector. Here, the block vector represents the displacement from the current block to the reference block. To increase coding efficiency, the video encoding apparatus may not transmit the block vector directly but divide the block vector into a block vector predictor (BVP) and a block vector difference (BVD), and encode and transmit the BVP and BVD to the video decoding apparatus.

In the sense of using block vectors, IBC has the characteristics of inter prediction. Therefore, IBC may be divided into IBC merge/skip mode and IBC AMVP mode (advanced motion vector prediction mode).

In the IBC merge/skip mode, the video encoding apparatus constructs an IBC merge list. From the perspective of coding efficiency optimization, the video encoding apparatus selects one block vector of the candidates included in the IBC merge list and may use the selected candidate as a block vector predictor (BVP). The video encoding apparatus determines a merge index indicating the selected block vector. However, the video encoding apparatus does not generate a BVD. The video encoding apparatus encodes and transmits the merge index to the video decoding apparatus. The IBC merge list may be constructed in the same manner by both the video encoding apparatus and the video decoding apparatus. The video decoding apparatus may decode and use the merge index to generate the block vector from the IBC merge list.

The video encoding apparatus in the IBC skip mode uses the same transmission method of block vectors as in the IBC merge mode, but does not transmit the residual block corresponding to the difference between the current block and the prediction block.

In the IBC AMVP mode, from the perspective of coding efficiency optimization, the video encoding apparatus determines the block vector and constructs the IBC AMVP list. The video encoding apparatus determines the candidate index that indicates one of the candidate block vectors included in the IBC AMVP list as the BVP. The video encoding apparatus calculates the BVD, which is the difference between the BVP and the block vector. Subsequently, the video encoding apparatus encodes the candidate index and BVD and transmits them to the video decoding apparatus.

The video decoding apparatus decodes the candidate index and BVD. The video decoding apparatus may obtain the BVP indicated by the candidate index from the IBC AMVP list, and sum the BVP and BVD to reconstruct the block vector.

In enhanced compression model (ECM), intra template matching prediction (IntraTMP) technology sets one or more L-shape, left, and/or top templates around the current block, searches for the template most similar to the current template in the reconstructed region of the current frame, and uses, as a prediction block of the current block, the block adjacent to the searched template and having the same size as the current block. The IntraTMP technique searches for similar templates based on a loss function, by using sum of absolute differences (SAD) as the loss function.

### II. CROSS-COMPONENT RESIDUAL MODEL (CCRM) AND CHROMA FROM LUMA (CFL)

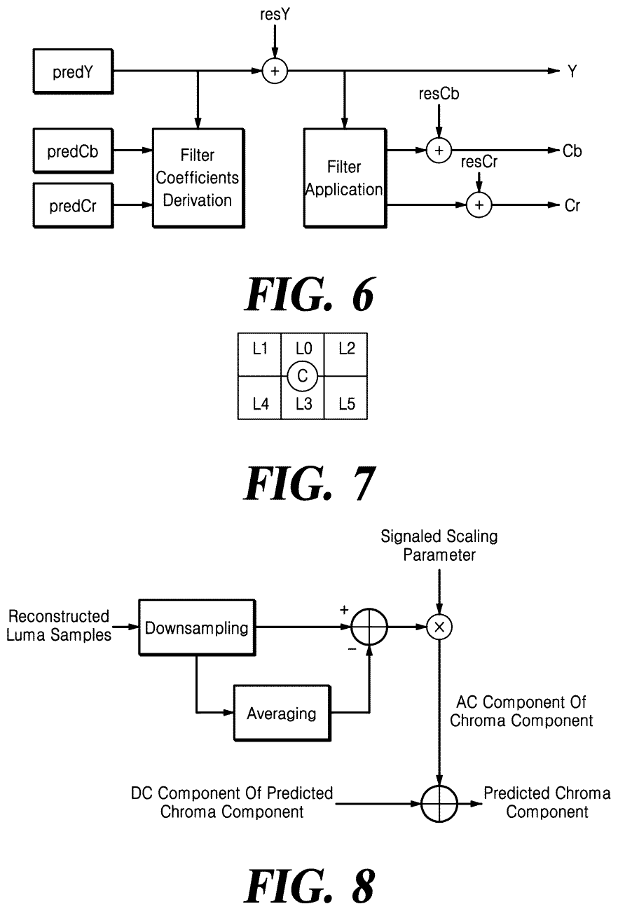

In ECM, the CCRM mode is applied to the prediction of chroma components when the corresponding luma block is predicted in the single tree according to the inter prediction or intra block copy mode (IBC mode). As illustrated in FIG. 6, the CCRM mode derives convolutional filter coefficients based on the relationship between the predicted signals of the corresponding luma components and the predicted signals of the chroma components. In the example in FIG. 6, predY represents the predicted signals of the corresponding luma components, and predCb and predCr represent the predicted signals of the chroma components. resY represents the residual signals of the luma component, and resCb and resCr represent the residual signals of the chroma component.

As shown in Equation 1, the CCRM mode predicts the chroma component by applying the derived filter to the reconstructed signals of the corresponding luma components shown in FIG. 7. In the example shown in FIG. 7, C indicates the position of the chroma sample generated by applying the derived filter.

predChromaVal=c0×L0+c1×L1+c2×L2+c3×L3+c4×L4+c5×L5+c6×nonlinear((L0+L3+1)>>1)+c7×B [Equation 1]

Here, the nonlinear function nonlinear(X) and offset B are defined by using the bit depth as shown in Equation 2.

nonlinear(X)=(X×X+(1<<(bitdepth−1))>>bitdepth B=1<<(bitdepth−1) [0124][Equation 2]

Filter coefficients c0 to c7 are derived from the predicted signals of the luma component and the predicted signals of the chroma component by using the Gaussian elimination method. At this time, the video encoding apparatus and the video decoding apparatus use the same method to derive the filter coefficients.

In the AV1 video codec, which is based on open source, the chroma from luma mode (CFL mode) predicts, during intra prediction, the AC component (alternating current component) of the chroma component by using the AC component of the reconstructed luma component, as illustrated in FIG. 8. The CFL mode subtracts the average, i.e., DC (direct current), from the reconstructed luma component to generate the AC component of the luma component. The CFL mode predicts the AC component of the chroma component by multiplying the AC component of the luma component by a scaling parameter, and uses reference samples to predict the DC component of the chroma component. The CFL mode sums the predicted DC component and AC component to generate the final predicted signals of the chroma component. The scaling parameter is generated by the video encoding apparatus and transmitted to the video decoding apparatus. At this time, the optimal scaling parameters for the Cb component and Cr component are transmitted, respectively.

As described above, the CCRM mode is applied to cross-component prediction in a single tree structure, and the CFL mode is applied to cross-component prediction in intra prediction. The following describes a method of applying the CFL mode to cross-component prediction in inter prediction or IBC mode, and a method of applying the CCRM mode to cross-component prediction in a dual tree structure.

The following examples are described with a focus on the video decoding apparatus, but they can be implemented in the same or similar manner in the video encoding apparatus.

### III. EMBODIMENTS OF THE PRESENT DISCLOSURE

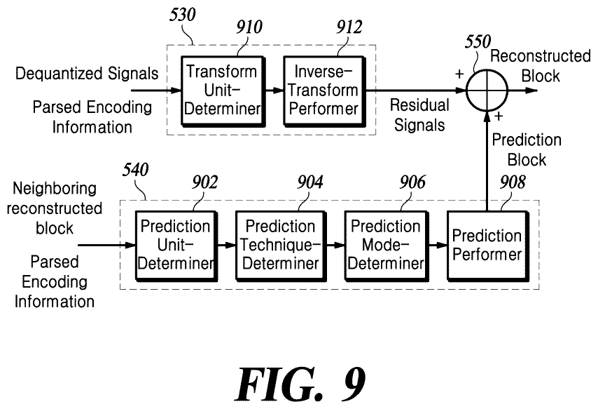

The video decoding apparatus according to some embodiments may determine prediction and transform units, and in response to a current block corresponding to the determined unit, may perform a prediction and an inverse transform by using a determined prediction technique and prediction mode, to finally generate a reconstructed block of the current block. The operations illustrated in FIG. 9 may be performed by the inverse transformer 530, the predictor 540, and the adder 550 of the video decoding apparatus. On the other hand, the same operations as illustrated in FIG. 9 may be performed by the inverse transformer 165, the picture splitter 110, the predictor 120, and the adder 170 of the video encoding apparatus. In this case, the video decoding apparatus uses encoding information parsed from the bitstream, but the video encoding apparatus may use encoding information set from a high level in terms of minimizing bit rate distortion. Hereinafter, for convenience, the embodiments are described centering on the video decoding apparatus.

As illustrated in FIG. 5, the predictor 540 includes the intra predictor 542 and the inter predictor 544, depending on the prediction technique, but as illustrated in FIG. 9, the predictor 540 may include all or part of a prediction unit-determiner 902, a prediction technique-determiner 904, a prediction mode-determiner 906, and a prediction performer 908.

If the color format of the input video is a YUV format (YUV420, YUV411, YUV422, YUV444, or the like), the video decoding apparatus may perform prediction and reconstruction of the luma component, and then may perform prediction and reconstruction of the chroma component. In this way, the luma component and the chroma component may be sequentially reconstructed by the components illustrated in FIG. 9. On the other hand, if the color format of the input video is RGB, the video encoding apparatus may perform a color format conversion from RGB to YUV, and then may encode the converted video. Here, in the YUV format, the color format represents a correspondence between pixels in the luma component and pixels in the chroma component.

The prediction unit-determiner 902 determines a prediction unit (PU). The prediction technique-determiner 904, in response to the prediction unit, determines a prediction technique, e.g., intra prediction, inter prediction, or intra block copy (IBC) mode, palette mode, or the like. The prediction mode-determiner 906 determines a detailed prediction mode for the prediction technique. The prediction performer 908 generates a prediction block of the current block according to the determined prediction mode.

The inverse transformer 530 includes a transform unit-determiner 910 and an inverse transform performer 912. The transform unit-determiner 910 determines a transform unit (TU) in response to the dequantized signals of the current block, and the inverse transform performer 912 inversely transforms the transform unit represented by the dequantized signals to generate residual signals.

The adder 550 sums the prediction block and the residual signals to generate a reconstructed block. The reconstructed block is stored in memory and may be used for predicting other blocks in the future.

The prediction unit determined by the prediction unit-determiner 902 may become the current block or one subblock of the subblocks split from the current block. In this case, the prediction unit of the chroma component may correspond in size to the prediction unit of the luma component, depending on the color format. Alternatively, the prediction units of the luma component and the chroma component may be determined separately, and the prediction may be performed in response to the prediction unit of the chroma component.

The prediction technique-determiner 904 determines a prediction technique for the prediction units. As described above, the prediction technique may be one of inter prediction, intra prediction, IBC mode, and palette mode. In this case, the prediction technique for the chroma component may be determined to be the same as the prediction technique of the corresponding luma component without signaling and parsing any additional information.

In one example, if the prediction technique of the current block is not intra prediction, the video decoding apparatus parses the 1-bit flag information. If the parsed flag indicates a skip mode, the video decoding apparatus may determine the prediction mode of the current block to be an inter prediction merge mode or an IBC merge mode. In the skip mode, the video decoding apparatus may also use the predicted signals in place of reconstructed signals, while skipping an inverse transform, i.e., without parsing residual signals.

On the other hand, if the parsed flag does not indicate a skip mode in response to the current block, the prediction technique-determiner 904 may determine one of the prediction techniques, such as inter prediction, intra prediction, IBC mode, palette mode, or the like, by parsing a series of 1-bit flags to be the prediction technique of the current block.

For example, if skip mode is not applied to the current block and the inter prediction or IBC mode is determined to be the prediction technique, the video decoding apparatus parses a 1-bit flag. The video decoding apparatus may determine, based on the parsed flag, the prediction mode of the current block to be the regular merge mode or AMVP (advanced motion vector prediction) mode.

The prediction mode-determiner 906 determines a detailed prediction mode for the prediction technique.

As an example, when the prediction technique for the current block is intra prediction, the prediction mode-determiner 906 may determine a single directional prediction mode, a planar mode (horizontal planar, vertical planar, or regular planar), or a DC mode as the prediction mode of the current block.

As another example, when the prediction technique of the current block is intra prediction, the prediction mode-determiner 906 may determine the intra TMP mode as the prediction mode of the current block.

The prediction performer 908 generates the prediction block of the current block according to the determined prediction technique and prediction mode.

As an example, the prediction performer 908 uses motion information to generate the prediction block of the current block, and the adder 550 generates the reconstructed block of the luma component. The prediction performer 908 performs cross-component prediction (CCP) based on the prediction block of the luma component, the reconstructed block of the luma component, and the prediction block of the chroma component to generate the prediction block of the chroma component, and the adder 550 generates the reconstructed block of the chroma component.

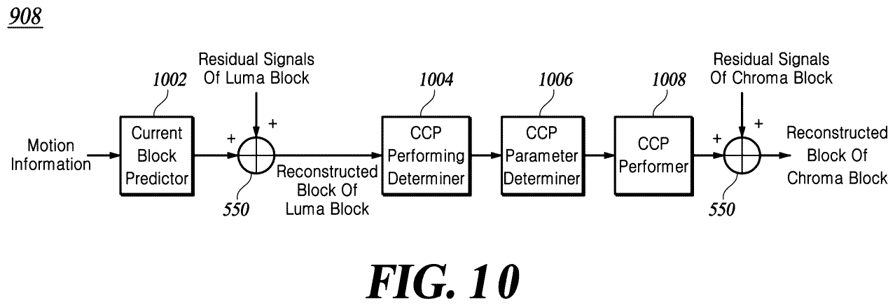

FIG. 10 is a block diagram showing in detail a prediction performer according to at least one embodiment of the present disclosure.

For cross-component prediction, the prediction performer 908 includes, as shown in FIG. 10, a current block predictor 1002, CCP performing determiner 1004, a CCP parameter determiner 1006, and a CCP performer 1008, as illustrated of FIG. 10. In the example shown in FIG. 10, further to the above-described prediction performer components, the adder 550 is included to generate a reconstructed block.

The current block predictor 1002 uses motion information to generate the prediction block of the current block, i.e., the prediction block of the luma block and the prediction block of the chroma block. In inter prediction, the motion information is the motion vector of the block or subblock, and in IBC mode, the motion information is the block vector. In IntraTMP mode, the motion information is the displacement between templates, i.e., the block vector.

Depending on the embodiment, when the inter-prediction mode is skip mode or merge/skip mode, cross-component prediction for the inter-prediction block may be additionally performed.

The adder 550 sums the prediction block of the luma block and the residual signals of the luma block to generate a reconstructed block of the luma component. As mentioned above, the residual signals of the luma component are generated by applying entropy decoding, inverse quantization, and inverse transform to the bitstream. Additionally, upon generating the prediction block of the chroma block, the adder 550 sums the prediction block of the chroma block and the residual signals of the chroma block to generate a reconstructed block of the chroma component. As mentioned above, residual signals of the chroma component are generated by applying entropy decoding, inverse quantization, and inverse transform to the bitstream.

The CCP performing determiner 1004 parses an additional flag to explicitly determine whether cross-component prediction is to be performed on the current chroma block. In this case, if the prediction mode of the corresponding luma block is inter prediction or block vector-based prediction mode (e.g., IBC or IntraTMP), the flag may be transmitted. Depending on the embodiment, the flag may be parsed in units of chroma blocks or transform blocks.

Whether cross-component prediction is to be performed may be determined in block units, and if the residual signals of the corresponding luma block are all zero, cross-component prediction may be skipped implicitly. Additionally, whether cross-component prediction is performed is determined in transform block units, and if the code block flag (CBF) in the corresponding luma transform unit is 0 (i.e., if all residual signals are zero), cross-component prediction may be skipped implicitly.

The CCP parameter determiner 1006 determines parameters for cross-component prediction.

As an example, the video decoding apparatus parses the AC-component scaling parameter β transmitted by the video encoding apparatus.

Scaling parameters may be parsed for each unit in which cross-component prediction is performed. The video decoding apparatus may receive scaling parameters for each of the Cb/Cr components. By parsing an index indicating one of a preset number of values defined according to an agreement between the video encoding apparatus and the video decoding apparatus, the scaling parameter may be determined according to the index. There may be multiple scaling parameter categories, and the value and number of scaling parameters may be defined differently for each category. To use the scaling parameters included in which one of the multiple categories may be determined based on neighboring information or related syntax elements.

As another example, the video decoding apparatus derives the scaling parameter based on reconstructed luma signals and reconstructed chroma signals. In this case, the video decoding apparatus may derive the scaling parameter by using the same method as used by the video encoding apparatus.

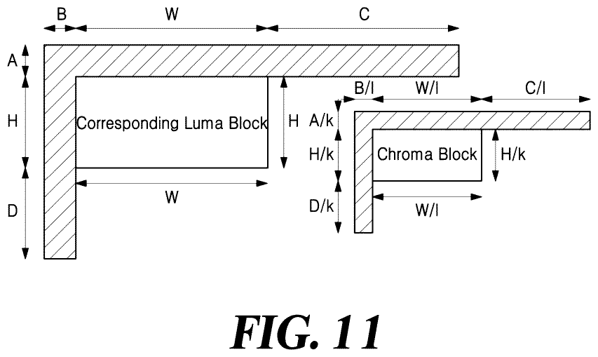

In cross-component prediction, when predicting the AC component of the chroma block from the AC component of the reconstructed luma block, the video decoding apparatus derives the scaling parameter based on the neighboring reconstructed luma signals and chroma signals. The reconstructed sample region for calculating the scaling parameter may be set as illustrated of FIG. 11 for the corresponding luma block and chroma block. Here, A, B, C, and D are integer values greater than or equal to 0 and may be defined based on the agreement between the video encoding apparatus and the video decoding apparatus, the size of the current block, and/or the availability of reference samples. In the example of FIG. 11, k and l may be determined based on the chroma format of the current picture. For example, when the chroma format is 4:2:0, k and l are set to 2.

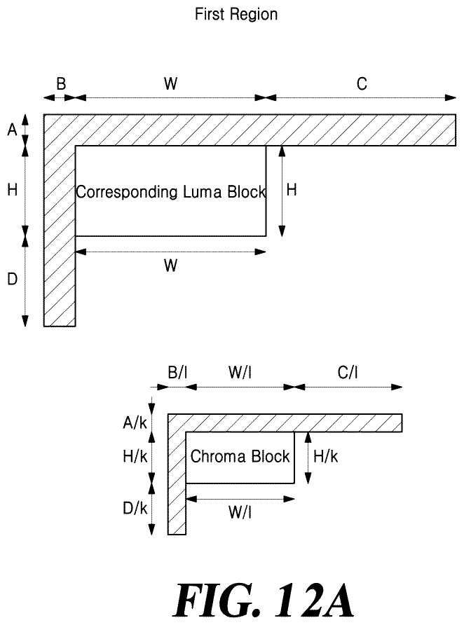

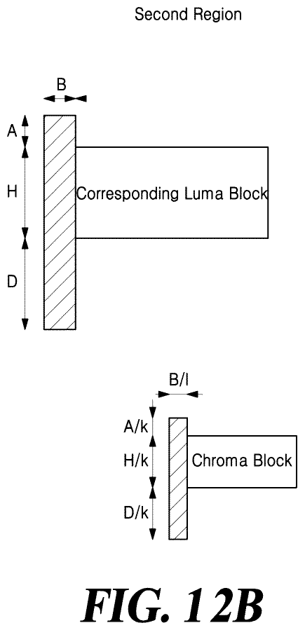

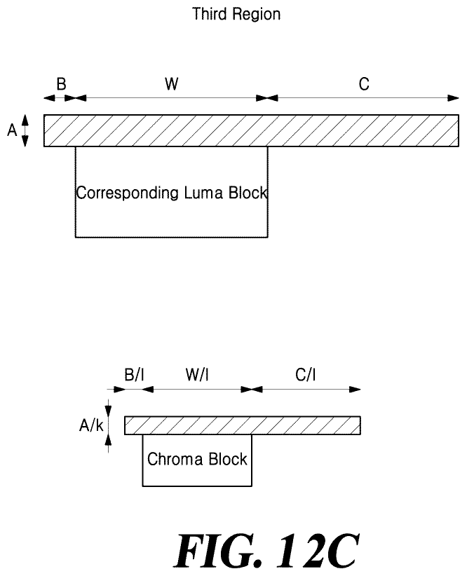

Depending on the embodiment, the region to be used for deriving the scaling parameter may be explicitly signaled among the first region, second region, and third region as shown in FIGS. 12A to 12C. In this case, A, B, C, and D are integer values greater than or equal to 0 and may be defined based on an agreement between the video encoding apparatus and the video decoding apparatus, the size of the current block, and/or the availability of reference samples. In the examples shown in FIGS. 12A to 12C, k and l may be determined based on the chroma format of the current picture. For example, when the chroma format is 4:2:0, k and l are set to 2.

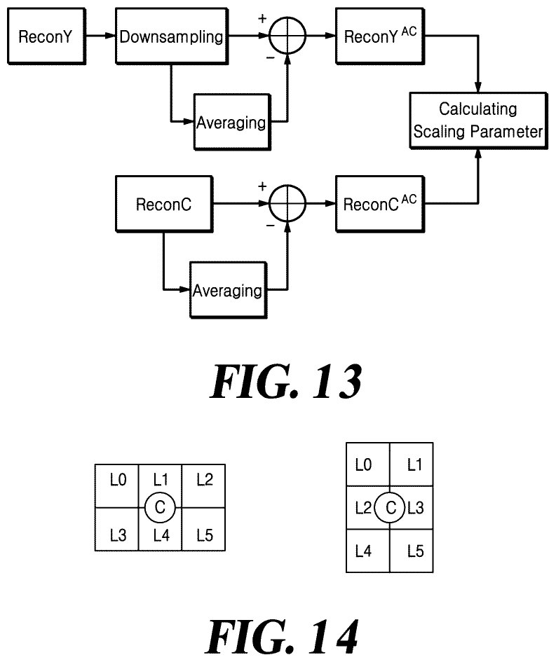

FIG. 13 is a diagram illustrating the derivation of scaling parameters according to at least one embodiment of the present disclosure.

The video decoding apparatus calculates the scaling parameter based on the reference sample region. The reference sample region used to derive the scaling parameter is predefined according to an agreement between the video encoding apparatus and the video decoding apparatus. Alternatively, the reference sample region may be explicitly determined by signaling.

The video decoding apparatus subtracts the average value of the reference sample region from the reconstructed luma values ReconY of the reference sample region of the corresponding luma block to calculate the AC values ReconY^{AC} of the luma component. The video decoding apparatus subtracts the average value of the reference sample region from the reconstructed chroma values ReconC of the reference sample region of the chroma block to calculate the AC values ReconC^{AC} of the chroma component. ReconC is either the Cb signals or the Cr signals. The video decoding apparatus may derive the scaling parameter based on the two AC components.

At this point, the video decoding apparatus may downsample the reconstructed luma values according to the current picture's chroma format (e.g., YCbCr 4:2:0, YCbCr 4:2:2, etc.) and may use the downsampled reconstructed luma values to calculate the AC values of the luma component.

The scaling parameter may be calculated based on linear regression according to Equation 3.

$$α = \frac{{\sum }_{i} {\sum }_{j} {ReconY}^{AC} ( i , j ) {ReconC}^{AC} ( i , j )}{{\sum }_{i} {\sum }_{j} {( {ReconY}^{AC} ( i , j ) )}^{2}} \qquad [ Equation 3 ]$$

Depending on the embodiment, the scaling parameter may be calculated by using the simplified Equation 4.

$$α = \frac{{\sum }_{k = 1}^{n} {Y}_{max}^{AC} ( k ) - {\sum }_{k = 1}^{n} {Y}_{min}^{AC} ( k )}{{\sum }_{k = 1}^{n} {X}_{max}^{AC} ( k ) - {\sum }_{k = 1}^{n} {X}_{min}^{AC} ( k )} \qquad [ Equation 4 ]$$

In Equation 4, X^{AC}ₘₐₓ(k) represents the kth largest value among the AC values calculated in the reference sample region of the reconstructed luma component, and Y^{AC}ₘₐₓ(k) represents the chroma value co-located with the luma pixel. X^{AC}ₘᵢₙ(k) represents the kth smallest value among the AC values calculated in the reference sample region of the reconstructed luma component, and Y^{AC}ₘᵢₙ(k) represents the chroma value co-located with the luma pixel.

As another example, the video decoding apparatus derives filter coefficients based on the reconstructed luma signals and reconstructed chroma signals. At this time, the video decoding apparatus may derive the filter coefficients by using the same method as that of the video encoding apparatus.

The video decoding apparatus calculates the filter coefficients based on one or more of the inter-predicted luma samples (predL), the offset (B) determined according to the bit depth, the output of a nonlinear function NL using an input of one or more inter-predicted luma samples, and inter-predicted chroma samples (predC). Here, the nonlinear function, the input \hat{L} to the nonlinear function, and the offset B may be defined in various ways, for example, as defined in Equation 5.

$$NL ( x ) = ( {x}^{2} + ( 1 ≪ ( bitDepthLuma - 1 ) ) ) ≫ bitDepthLuma \qquad [ Equation 5 ]$$

$$L = \frac{{\sum }_{i = 0}^{N - 1} predL ( i )}{N}$$

$$B = 1 << ( bitDepthLuma - 1 )$$

In Equation 5, i represents a particular position in the corresponding luma block, defined according to an agreement between the video encoding apparatus and the video decoding apparatus, based on the position of the current chroma sample, and predL(i) represents the predicted value of the luma component at position i.

The video decoding apparatus predicts the chroma signals according to Equation 6.

predC=c₀L0+c₁L1+c₂L2+c₃L3+c₄L4+c₅L5+c₆NL(L)+c₇B [Equation 6]

In Equation 6, L0 to L5 represent the reconstructed signals of the corresponding luma components. Furthermore, to calculate the filter coefficients, the matrix multiplication in the form Lx=C shown in Equation 7 is processed by using methods such as Gaussian elimination or Cholesky decomposition.

$$[ \begin{matrix}predL {0}_{0} & predL {1}_{0} & ⋯ & predL {5}_{0} & NL ( pred {\hat{L}}_{0} ) & B \\ predL {0}_{1} & predL {1}_{1} & ⋯ & predL {5}_{1} & NL ( pred {\hat{L}}_{1} ) & B \\ ⋮ & & ⋮ & & & ⋮ \\ predL {0}_{n - 2} & predL {1}_{n - 2} & ⋯ & predL {5}_{n - 2} & NL ( pred {\hat{L}}_{1} ) & B \\ predL {0}_{n - 1} & predL {1}_{n - 1} & ⋯ & predL {5}_{n - 1} & NL ( pred {\hat{L}}_{n - 1} ) & B\end{matrix} ] [ \begin{matrix}{c}_{0} \\ {c}_{1} \\ {c}_{2} \\ {c}_{3} \\ {c}_{4} \\ {c}_{5} \\ {c}_{6} \\ {c}_{7}\end{matrix} ] = [ \begin{matrix}{predC}_{0} \\ {predC}_{1} \\ ⋮ \\ {predC}_{n - 2} \\ {predC}_{n - 1}\end{matrix} ] \qquad [ Equation 7 ]$$

When the chroma format of the current picture is 4:2:0, 4:2:2, or the like, for example, inter-predicted samples within the corresponding luma block as shown in FIG. 14 may be used to perform the derivation of filter coefficients and the prediction of chroma components. At this time, the positions of the inter-predicted samples within the corresponding luma block are determined according to an agreement between the video encoding apparatus and the video decoding apparatus. Alternatively, the positions of the inter-predicted samples within the corresponding luma block may be determined explicitly according to signaling in units such as slices, pictures, sequences, or the like. In the example of FIG. 14, C indicates the position of the chroma sample predicted by the application of the derived filter.

As inter-predicted samples within the corresponding luma block used for predicting the chroma component and deriving filter coefficients, the video decoding apparatus may use values obtained by subtracting an offset from said predicted samples. In this case, the offset may be calculated according to Equation 8 depending on the bit depth of the luma signal.

lumaOffset=1<<(bitDepthLuma−1) [Equation 8]

The CCP performer 1008 generates predicted signals of the chroma component based on cross-component prediction.

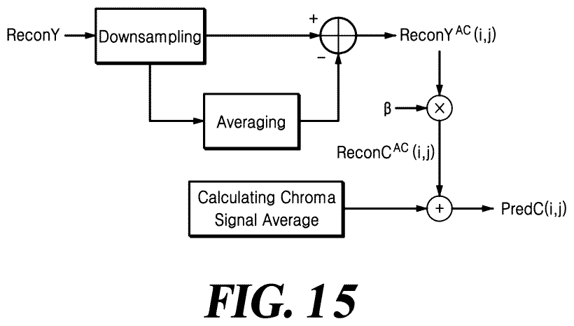

FIG. 15 is a diagram illustrating the cross-component prediction of chroma components, according to at least one embodiment of the present disclosure.

As an example, the video decoding apparatus uses the AC scaling parameter β to generate predicted signals of the chroma component. The video decoding apparatus predicts the AC values of the chroma component by using the corresponding reconstructed luma signals and the scaling parameters derived from the CCP parameter determiner 1006 or parsed from the bitstream. The video decoding apparatus uses the AC scaling parameter to perform chroma component prediction, as illustrated in FIG. 15.

When downsampling of the corresponding luma block's reconstructed samples ReconY is required depending on the chroma format of the current picture, the video decoding apparatus performs downsampling and then subtracts from the downsampled luma reconstruction samples the average value of the corresponding luma block to calculate the AC values of the luma component. The video decoding apparatus multiplies the reconstructed luma AC value ReconY^{AC}(i,j) at each location by the scaling parameter to calculate the chroma component AC values ReconC^{AC}(i,j). The video decoding apparatus sums the AC values of the chroma component and the average value of the chroma component to generate the final chroma predicted signals. At this time, the video decoding apparatus calculates the average value of the chroma component based on the already reconstructed neighboring chroma reference sample. Alternatively, the video decoding apparatus may use the motion information used in predicting the corresponding luma block to perform motion compensation of the chroma component, and then may use the average value of the chroma predicted signals for the average value of the chroma component. Here, the motion information may be a motion vector according to inter prediction, or a block vector according to IBC mode or IntraTMP mode, as described above.

As another example, the video decoding apparatus uses a filter derived by the CCP parameter determiner 1006 to generate predicted signals of the chroma component. For example, the video decoding apparatus may follow Equation 6 to use a filter for generating predicted signals of the chroma component. In Equation 6, L0 to L5 represent reconstructed luma samples generated by summing the corresponding luma component's inter predicted signals and reconstructed residual signals. Here, the luma component inter predicted signals are signals predicted based on motion vectors. The video decoding apparatus applies the derived filter to the reconstructed sample values of the corresponding luma block to generate final chroma predicted signals.

As yet another example, when the corresponding luma block is predicted according to the Intra Block Copy (IBC) or IntraTMP mode, the video decoding apparatus performs the derivation of filter coefficients and prediction of the chroma component in the same manner as with the inter-predicted block. At this time, the video decoding apparatus uses the luma predicted signals and chroma predicted signals predicted according to the block vector for deriving the filter coefficients.

The following describes the case where multiple luma blocks correspond to a single chroma block according to the application of the dual tree structure. Multiple luma blocks corresponding to the chroma region are represented as a corresponding luma region.

For example, when whether cross-component prediction is to be performed is determined in block units, and when the luma block co-located with the center of the current chroma block is predicted according to an inter prediction mode that utilizes a motion vector, or a prediction mode (IBC or IntraTMP) that utilizes a block vector, the video decoding apparatus may additionally parse a flag to determine whether cross-component prediction is to be performed. On the other hand, if the residual signals of the luma block co-located with the center of the current chroma block are all zero, cross-component prediction may be skipped implicitly.

Furthermore, when whether the prediction is to be performed is determined for each transform unit (TU), the prediction mode of the luma block co-located with the center of the TU is used. For example, when the luma block co-located with the center of the TU is predicted according to the prediction mode that utilizes a motion vector or a block vector, the video decoding apparatus may parse the flag to determine whether cross-component prediction is to be performed. On the other hand, if the CBF of the luma block co-located with the center of the TU is 0 (all residual signals are zero), cross-component prediction may be skipped implicitly.

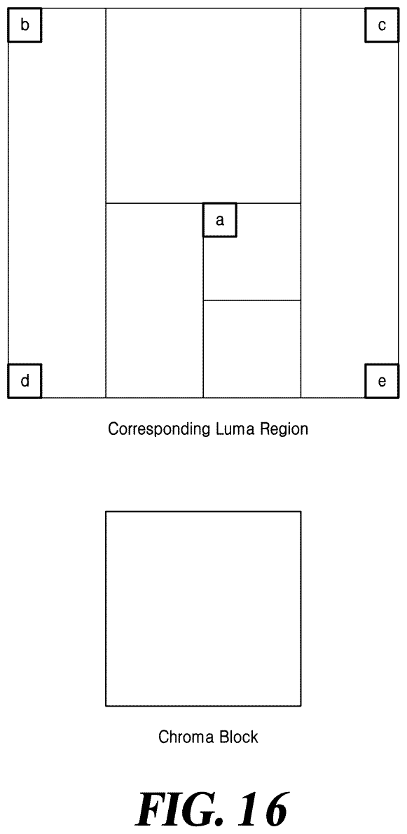

An example checks the prediction mode of predefined positions within the corresponding luma region according to a predefined order, if there is a luma block predicted by using a prediction mode that utilizes a motion vector or block vector, the video decoding apparatus may parse the flag to determine whether cross-component prediction is to be performed. At this time, the preset order and predefined positions within the corresponding luma region may be provided according to an agreement between the video encoding apparatus and the video decoding apparatus. The predefined positions within the corresponding luma region may include the region's center, top left, top right, bottom left, and bottom right, as illustrated in FIG. 16.

On the other hand, when at specified locations there are multiple blocks predicted according to the prediction mode that utilizes a motion vector or block vector, the video decoding apparatus utilizes the first block in the specified order, which is predicted according to the prediction mode that utilizes the motion vector or block vector. So, the video decoding apparatus may derive the filter coefficients by using the first block's motion vector or block vector and may use the derived filter to perform the cross-component prediction.

As an example, when filter coefficients are derived based on signals predicted according to motion information and the derived filter is used to predict chroma components, the video decoding apparatus may average or weighted-sum the chroma predicted signals generated by using the filter and the chroma predicted signals generated according to motion information, thereby generating final predicted signals. Here, the motion information may be a motion vector according to inter prediction, or a block vector according to IBC mode or IntraTMP mode, as described above. When cross-component prediction is performed, the video decoding apparatus may always perform weighted-summed prediction. Alternatively, the video decoding apparatus may explicitly parse a flag to further determine whether the weighted-summed prediction is to be performed.

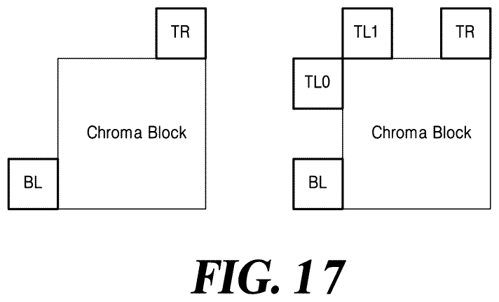

The weights for weighted-summation may be predefined according to an agreement between the video encoding apparatus and the video decoding apparatus. Alternatively, the video decoding apparatus may calculate the weights for predicted signals according to motion information and cross-component predicted signals, based on prediction mode information of neighboring blocks. When calculating weights based on the prediction modes of neighboring blocks, the locations for checking prediction modes may vary depending on the embodiment. As illustrated in FIG. 17, the video decoding apparatus may check the prediction modes of neighboring blocks at locations such as TR/BL or TR/BL/TL0/TL1 to derive weights.

The video decoding apparatus defines the number Nᵢₙₜₑᵣ of inter-predicted blocks among the prediction modes of neighboring blocks about the current chroma block, and the number Nₙₒₙᵢₙₜₑᵣ of non-inter-predicted blocks. At this time, Nᵢₙₜₑᵣ may include blocks predicted according to a prediction mode that utilizes a block vector. The video decoding apparatus may determine the weights Wᵢₙₜₑᵣ for the predicted signals according to motion information and the weights W_{interCC} for the cross-component predicted signals as shown in Table 1.

TABLE 1

| Condition | (wᵢₙₜₑᵣ, w_{interCC}) |
|---|---|
| Nᵢₙₜₑᵣ > Nₙₒₙᵢₙₜₑᵣ | (2^{p} − q₀, q₀) |
| Nᵢₙₜₑᵣ = Nₙₒₙᵢₙₜₑᵣ | (2^{p-1}, 2^{p-1}) |
| Nᵢₙₜₑᵣ < Nₙₒₙᵢₙₜₑᵣ | (q₁, 2^{p} − q₁) |

In Table 1, 2^{p} is used to divide the predicted values according to the weighted-summation. q₀ (2^{p}−q₀>q₀) and q₁ (2^{p}−q₁>q₁) are values defined according to an agreement between the video encoding apparatus and the video decoding apparatus.

When performing weighted-summation, the video decoding apparatus generates the final prediction values of the chroma component according to Equation 9.

P=(Wᵢₙₜₑᵣ×Pᵢₙₜₑᵣ+W_{interCC}×P_{interCC}+2^{p-1})>>p [Equation 9]

In Equation 11, Pᵢₙₜₑᵣ represents the predicted signals of the chroma component generated according to inter prediction, and P_{interCC} represents the predicted signals of the chroma component generated according to cross-component prediction. At this time, Pᵢₙₜₑᵣ may be the predicted signals of the chroma block generated according to the prediction mode that utilizes the block vector.

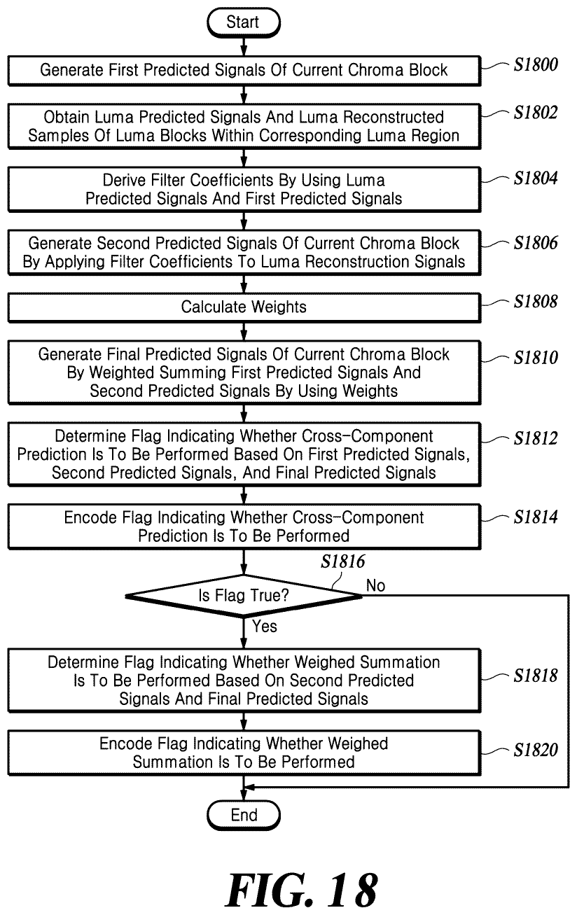

The following describes, by using the illustrations in FIGS. 18 to 21, a method for cross-component prediction of the current chroma block based on the derived filter coefficients. The following case describes multiple luma blocks corresponding to a single chroma block following the application of a dual tree structure. Multiple luma blocks corresponding to the chroma region are represented as a corresponding luma region.

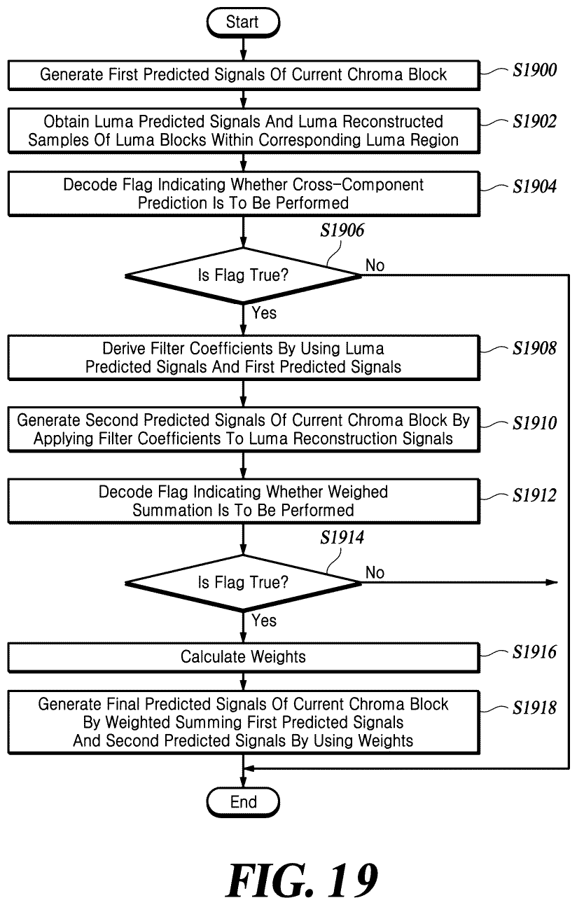

FIGS. 18 and 19 illustrate the use of a flag indicating whether weighted-summation is to be performed on the two predictors.

FIG. 18 is a flowchart of a method of encoding a current chroma block by the video encoding apparatus, according to at least one embodiment of the present disclosure.

The video encoding apparatus uses motion information to generate first predicted signals for the current chroma block (S1800). Here, in inter prediction, the motion information is the motion vector of the block or subblock, and in IBC mode, the motion information is the block vector. In IntraTMP mode, the motion information is the displacement between templates, i.e., the block vector.

The video encoding apparatus obtains the luma predicted signals and luma reconstruction samples of the luma blocks within the corresponding luma region (S1802).

The video encoding apparatus performs cross-component prediction when the luma block co-located with the center of the current chroma block is predicted according to the prediction mode that utilizes motion information.

The video encoding apparatus implicitly skips cross-component prediction when all residual signals of the luma block co-located with the center of the current chroma block are zero.

The video encoding apparatus performs cross-component prediction when whether the prediction is to be performed is determined for each transform unit and when the luma block co-located with the center of the transform unit is predicted according to the prediction mode that utilizes motion information.

The video encoding apparatus implicitly skips cross-component prediction when all residual signals of the luma block co-located with the center of the transform unit are zero.

The video encoding apparatus checks the prediction mode of predetermined positions within the corresponding luma region according to a preset order, and when there is a luma block predicted according to a prediction mode that utilizes motion information, it performs cross-component prediction.

The video encoding apparatus uses the luma predicted signals and the first predicted signals to derive filter coefficients for cross-component prediction of the current chroma block (S1804).

The video encoding apparatus derives filter coefficients based on one or more of the luma predicted signals, an offset (B) determined according to bit depth, the output of a nonlinear function (NL) that uses an input of one or more luma predicted signals, and the first predicted signals.

The video encoding apparatus applies the filter coefficients to luma reconstruction signals to generate second predicted signals of the current chroma block (S1806).

The video encoding apparatus calculates the predicted signal of the current chroma sample by applying the derived filter coefficients to the luma reconstruction samples corresponding to the current chroma sample, the output of the nonlinear function, and the offset.

The video encoding apparatus calculates weights (S1808). The video encoding apparatus calculates the weights for the first predicted signals and the second predicted signals based on the prediction modes of the neighboring blocks of the current chroma block.

The video encoding apparatus uses the weights to weighted-sum the first predicted signals and the second predicted signals, thereby generating the final predicted signals of the current chroma block (S1810).

The video encoding apparatus determines a flag indicating whether cross-component prediction is to be used, based on the first predicted signals, the second predicted signals, and the final predicted signals (S1812).

In terms of rate-distortion optimization, the video encoding apparatus determines the flag indicating whether cross-component prediction is to be performed. For example, if the first predicted signals are optimal, the flag is determined to be false. On the other hand, if the second predicted signals or the final predicted signals are optimal, the flag is determined to be true.

The video encoding apparatus encodes the flag indicating whether cross-component prediction is to be performed (S1814).

The video encoding apparatus checks the flag indicating whether cross-component prediction is to be performed (S1816).

If the flag indicating whether cross-component prediction is to be performed is true (Yes in S1816), the video encoding apparatus performs the following steps.

The video encoding apparatus determines a flag indicating whether weighted-summation is to be performed, based on the second predicted signals and the final predicted signals (S1818).

From the perspective of rate-distortion optimization, the video encoding apparatus determines the flag indicating whether weighted-summation is to be performed. For example, if the second predicted signals are optimal, the flag is determined to be false. On the other hand, if the final predicted signals are optimal, the flag is determined to be true.

The video encoding apparatus encodes the flag indicating whether weighted-summation is to be performed (S1820).

If the flag indicating whether cross-component prediction is to be performed is false (No in S1816), the video encoding apparatus skips determining and encoding of the flag indicating whether weighted-summation is to be performed.

Thereafter, the video encoding apparatus follows the flag indicating whether cross-component prediction is to be performed and the flag indicating whether weighted-summation is to be performed to subtract from the current chroma block the first predicted signals, second predicted signals, or final predicted signals, thereby generating the residual signals. The video encoding apparatus transforms/quantizes the residual signals to generate and encode quantized transform coefficients.

FIG. 19 is a flowchart of a method of reconstructing a current chroma block by the video decoding apparatus, according to at least one embodiment of the present disclosure.

The video decoding apparatus uses motion information to generate first predicted signals of the current chroma block (S1900). Here, in inter prediction, the motion information is the motion vector of the block or subblock, and in IBC mode, the motion information is the block vector. In IntraTMP mode, the motion information is the displacement between templates, i.e., the block vector.

The video decoding apparatus obtains the luma predicted signals and luma reconstruction samples of the luma blocks within the corresponding luma region (S1902).

The video decoding apparatus decodes from the bitstream a flag indicating whether cross-component prediction is to be performed (S1904).

The video decoding apparatus decodes the flag when the luma block co-located with the center of the current chroma block is predicted according to the prediction mode that utilizes the motion information.

The video decoding apparatus implicitly skips cross-component prediction if all residual signals of the luma block co-located with the center of the current chroma block are zero.

The video decoding apparatus decodes the flag when whether the prediction is to be performed is determined for each transform unit and the luma block co-located with the center of the transform unit is predicted according to the prediction mode that utilizes the motion information.

The video decoding apparatus implicitly skips cross-component prediction when all residual signals of the luma block co-located with the center of the transform unit are zero.

The video decoding apparatus checks the prediction mode of predefined positions within the corresponding luma region according to a preset order to find the presence of a luma block predicted according to a prediction mode that utilizes the motion information, when it decodes the flag.

The video decoding apparatus checks the flag indicating whether cross-component prediction is to be performed (S1906).

If the flag indicating whether cross-component prediction is to be performed is false (No in S1906), the video decoding apparatus determines the first predicted signals as the final predicted signals of the current chroma block.

On the other hand, if the flag indicating whether cross-component prediction is to be performed is true (Yes in S1906), the video decoding apparatus performs the following steps.

The video decoding apparatus uses the luma predicted signals and the first predicted signals to derive filter coefficients for cross-component prediction of the current chroma block (S1908).

The video decoding apparatus derives the filter coefficients based on one or more of the luma predicted signals, an offset (B) determined according to the bit depth, the output of a nonlinear function (NL) that uses an input of one or more luma predicted signals, and the first predicted signals.

The video decoding apparatus applies the filter coefficients to the luma reconstruction samples to generate the second predicted signals of the current chroma block (S1910).

The video decoding apparatus applies the derived filter coefficients to the luma reconstruction samples corresponding to the current chroma sample, the output of the nonlinear function, and the offset to calculate the predicted signal of the current chroma sample.

The video decoding apparatus decodes the flag indicating whether weighted-summation is to be performed (S1912).

The video decoding apparatus checks the flag indicating whether weighted-summation is to be performed (S1914).

If the flag indicating whether weighted-summation is to be performed is false (No in S1914), the video decoding apparatus determines the second predicted signals as the final predicted signals of the current chroma block.

If the flag indicating whether weighted-summation is to be performed is true (Yes in S1914), the video decoding apparatus performs the following steps.

The video decoding apparatus calculates weights (S1916). The video decoding apparatus calculates the weights for the first predicted signals and the weights for the second predicted signals based on the prediction modes of the neighboring blocks of the current chroma block.

The video decoding apparatus uses the weights to weighted-sum the first predicted signals and the second predicted signals, thereby generating the final predicted signals of the current chroma block (S1918).

The video decoding apparatus decodes the quantized transform coefficients from the bitstream, inverse quantizes/inverse transforms the quantized transform coefficients to reconstruct the residual signals, and sums the final predicted signals and the residual signals to generate the reconstructed signals of the current chroma block.

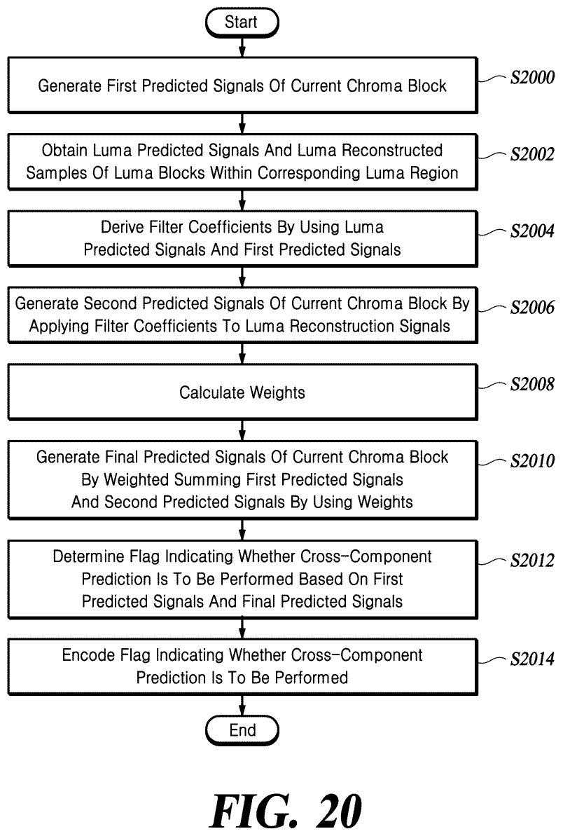

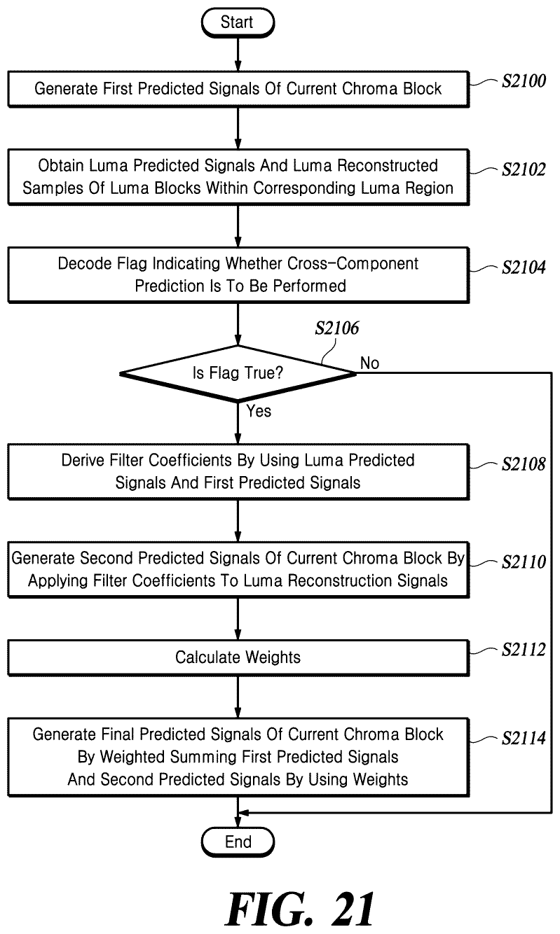

FIGS. 20 and 21 illustrate weight summation constantly performed without using a flag indicating whether the weighted-sum is to be performed on two predictors.

FIG. 20 is a flowchart of a method of encoding a current chroma block by the video encoding apparatus, according to another embodiment of the present disclosure.

In FIG. 20, Steps S2000 to S2010 are performed in the same manner as in FIG. 18, which are the generating of the first predicted signals of the current chroma block to the generating of the final predicted signals of the current chroma block. Hereinafter, the steps that differ from those shown in FIG. 18 are described.

The video encoding apparatus determines the flag indicating whether cross-component prediction is to be performed, based on the first predicted signals and the final predicted signals (S2012).

In terms of rate-distortion optimization, the video encoding apparatus determines the flag indicating whether cross-component prediction is to be performed. For example, if the first predicted signals are optimal, the flag is determined to be false. On the other hand, if the final predicted signals are optimal, the flag is determined to be true.

The video encoding apparatus encodes the flag indicating whether cross-component prediction is to be performed (S2014).

Subsequently, the video encoding apparatus follows the flag indicating whether cross-component prediction is to be performed to subtract from the current chroma block the first predicted signals or the final predicted signals, thereby generating the residual signals. The video encoding apparatus transforms/quantizes the residual signals to generate and encodes quantized transform coefficients.

FIG. 21 is a flowchart of a method of encoding a current chroma block by the video encoding apparatus, according to another embodiment of the present disclosure.

In the illustration of FIG. 21, Steps S2100 to S2110 are performed in the same manner as in FIG. 19, which are the generating of the first predicted signals of the current chroma block through the generating of the second predicted signals of the current chroma block. Hereinafter, the steps that differ from those shown in FIG. 19 are described.

The video decoding apparatus calculates weights (S2112). The video decoding apparatus calculates the weights for the first predicted signals and the second predicted signals based on the prediction modes of the neighboring blocks of the current chroma block.

The video decoding apparatus uses the weights to weighted-sum the first predicted signals and the second predicted signals, thereby generating the final predicted signals of the current chroma block (S2114).

The video decoding apparatus decodes the quantized transform coefficients from the bitstream and inverse quantizes/inverse transforms the quantized transform coefficients to reconstruct the residual signals. The video decoding apparatus sums the final predicted signals and the residual signals to generate the reconstructed signals of the current chroma block.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

### REFERENCE NUMERALS

120: predictor
540: predictor
902: prediction unit-determiner
904: prediction technique-determiner
906: prediction mode-determiner
908: prediction performer
1002: current block predictor
1004: CCP performing determiner
1006: CCP parameter determiner
1008: CCP performer

### CROSS-REFERENCE TO RELATED APPLICATIONS

This application claims priority to and the benefit of Korean Patent Application No. 10-2023-0062589 filed on May 15, 2023, and Korean Patent Application No. 10-2024-0041180, filed on Mar. 26, 2024, the entire contents of each of which are incorporated herein by reference.

What is claimed is:

1. A method of reconstructing a current chroma block by a video decoding apparatus, the method comprising:
generating first predicted signals of the current chroma block by using motion information that is a motion vector or a block vector;
obtaining luma predicted signals and luma reconstruction samples of luma blocks in a corresponding luma region;
deriving filter coefficients for cross-component prediction of the current chroma block by using the luma predicted signals and the first predicted signals; and
generating second predicted signals of the current chroma block by applying the filter coefficients to the luma reconstruction samples.

2. The method of claim 1, further comprising:
decoding from the bitstream a flag indicating whether the cross-component prediction is to be performed; and
checking the flag,
wherein the method proceeds, when the flag is true, with deriving the filter coefficients.

3. The method of claim 2, wherein the method proceeds with decoding the flag when a luma block co-located with a central position of the current chroma block is predicted according to a prediction mode that utilizes the motion information.

4. The method of claim 2, further comprising:
implicitly omitting the cross-component prediction when residual signals of a luma block co-located with a central position of the current chroma block are all zero.

5. The method of claim 2, wherein the method proceeds with decoding the flag when whether prediction is to be performed is determined for each transform unit and a luma block co-located with a central position of the transform unit is predicted according to a prediction mode that utilizes the motion information.

6. The method of claim 5, further comprising:
implicitly omitting the cross-component prediction when residual signals of a luma block co-located with a central position of the transform unit are all zero.

7. The method of claim 2, wherein the method proceeds with decoding the flag when a luma block predicted according to a prediction mode that utilizes the motion information exists by checking, in a preset order, prediction modes of predetermined positions in the corresponding luma region.

8. The method of claim 1, further comprising:
obtaining weights; and
generating final predicted signals of the current chroma block by weighted-summing the first predicted signals and the second predicted signals by using the weights.

9. The method of claim 8, wherein obtaining the weights comprises:
using weights that are predefined according to an agreement between a video encoding apparatus and the video decoding apparatus.

10. The method of claim 1, wherein deriving the filter coefficients comprises:
deriving the filter coefficients based on one or more of (1) the luma predicted signals, (2) an offset determined by a bit depth, (3) an output of a nonlinear function using an input of one or more of the luma predicted signals, and (4) the first predicted signals.

11. The method of claim 1, wherein generating the second predicted signals comprises:
calculating a predicted signal of the current chroma sample by applying the filter coefficients to (1) the luma reconstruction samples corresponding to a current chroma sample, (2) the output of the nonlinear function, and (3) the offset.

12. A method of encoding a current chroma block by a video encoding apparatus, the method comprising:
generating first predicted signals of the current chroma block by using motion information that is a motion vector or a block vector;
obtaining luma predicted signals and luma reconstruction samples of luma blocks in a corresponding luma region;
deriving filter coefficients for cross-component prediction of the current chroma block by using the luma predicted signals and the first predicted signals; and
generating second predicted signals of the current chroma block by applying the filter coefficients to the luma reconstruction samples.

13. The method of claim 12, wherein the method proceeds with deriving the filter coefficients when a luma block co-located with a central position of the current chroma block is predicted according to a prediction mode that utilizes the motion information.

14. The method of claim 12, further comprising:
obtaining weights; and
generating final predicted signals of the current chroma block by weighted-summing the first predicted signals and the second predicted signals by using the weights.

15. The method of claim 14, further comprising:
determining a flag indicating whether the cross-component prediction is to be performed based on the first predicted signals and the final predicted signals; and
encoding the flag indicating whether the cross-component prediction is to be performed.

16. A computer-readable recording medium storing a bitstream generated by a video encoding method, wherein the video encoding method comprises:
generating first predicted signals of a current chroma block by using motion information that is a motion vector or a block vector;
obtaining luma predicted signals and luma reconstruction samples of luma blocks in a corresponding luma region;
deriving filter coefficients for cross-component prediction of the current chroma block by using the luma predicted signals and the first predicted signals; and
generating second predicted signals of the current chroma block by applying the filter coefficients to the luma reconstruction samples.
